(19) United States
(12) Patent Application Publication
(10) Pub. No.: US 2004/0093497 A1
(43) Pub. Date: May 13, 2004

(54) Authentication and ownership system, method and database

(76) Inventor: Joseph P. Arangio, West Kill, NY (US)

Correspondence Address: Richard C. Litman, LITMAN LAW OFFICES, LTD., P.O. Box 15035, Arlington, VA, 22215, US

(21) Appl. No.: 10/290,265

(22) Filed: Nov. 8, 2002

(51) Int. Cl. H04L 9/00

(52) U.S. Cl. 713/176

(57) ABSTRACT

An authentication and ownership system, method and database having the following functions: item identification, notarization, registration, control, affidavit, and authentication. The system, method and database enable a person or company (the “authenticator”) to control the methodology whereby an item is autographed and thus provide validity, authentication and integrity in the collector marketplace. The present invention substantially reduces counterfeiting and fraud.

The system, method and database may have a registration transfer function. The system may have a database, and the method may have a database entry step. The database may be a relational database.

### BACKGROUND OF THE INVENTION

1. Field of the Invention

The present invention relates to an authentication and ownership system, an authentication and ownership method, and an authentication and ownership database for one or more items to be signed or previously autographed items.

2. Description of the Related Art

According to the Federal Bureau of Investigation, $500 million in revenue is lost every year due to fraud in the memorabilia market. In particular, autographed items are frequently subject to counterfeiting. The authenticity problem is exacerbated by online auctioning sites where false claims and sales can be made anonymously. Even with a live sale, a buyer does not know whether a particular item is a forgery.

For example, a legitimate collector attends a memorabilia show and pays to have four baseballs signed by Mickey Mantle. The collector keeps the receipts from the show, retains a copy of the money orders used to pay for the signatures, and makes a photograph of Mr. Mantle signing the baseballs. Now, the collector has four baseballs potentially worth ten or twenty times the amount he paid at the show. However, even with the receipts, copies of the money orders, and photograph, the collector still cannot definitively assure a potential buyer that the baseball being sold is the same one signed at the show by Mr. Mantle. At best, the collector may have a professional review the signature and attest to its authenticity, but such procedures are costly and not completely accurate. The collector may potentially lose a substantial portion or the entire value of the potential return on his or her investment.

A variety of devices and methods have been proposed for authenticating signatures. U.S. Pat. No. 5,737,886, issued Apr. 14, 1998 to Kruckemeyer, describes a method for determining forgeries and authenticating signatures. U.S. Pat. No. 5,971,435, issued Oct. 26, 1999 to DiCesare et al., describes a method and system for verifying the authenticity of an autograph. U.S. Pat. No. 5,973,731, issued Oct. 26, 1999 to Schwab, describes a secure identification system.

U.S. Pat. No. 6,081,610, issued Jun. 27, 2000 to Dwork et al., describes a system and method for verifying signatures on documents. U.S. Pat. No. 6,082,774, issued Jul. 4, 2000 to Schlauch, describes memorabilia articles having integral collectable attractiveness attributes. U.S. Pat. No. 6,308,277 B1, issued Oct. 23, 2001 to Vaeth et al., describes a virtual certificate authority. U.S. Pat. No. 6,341,169 B1, issued Jan. 22, 2002 to Cadorette, Jr. et al., describes a system and method for evaluating a document and creating a record of the evaluation process and an associated transaction.

None of the above inventions and patents, taken either singularly or in combination, is seen to describe the instant invention as claimed. Thus an authentication and ownership system, method and database solving the aforementioned problems is desired.

### SUMMARY OF THE INVENTION

The present invention is directed to an authentication and ownership system, an authentication and ownership method, and an authentication and ownership database for one or more items to be signed or previously autographed items. The present invention establishes the authenticity and ownership of an autographed item by uniquely identifying the item to be signed, witnessing the signing of the item by an authorized notary, registering the uniquely identified item, controlling all information related to the signing and transfer of ownership of the item, attesting to the signing of the item on an affidavit, and issuing a certificate of authenticity to the owner of the item. The owner may then transfer ownership of the autographed item to another.

Accordingly, it is a principal object of the invention to provide an authentication and ownership system, method, and database for one or more items to be signed or previously autographed items.

It is another object of the invention to provide an authentication and ownership system comprising an item identification system, a notarization system, a registration system, a control system, an affidavit system, and an authentication system.

It is a further object of the invention to provide an authentication and ownership method comprising an item identification step, a notarization step, a registration step, a control step, an affidavit step, and an authentication step.

Still another object of the invention is to provide an authentication and ownership database comprising an item identification form, a notarization form, a registration form, a control form, an affidavit form, and an authentication form.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1A is an authentication and ownership system according to the present invention.

FIG. 1B is a continuation of FIG. 1A.

FIG. 2A is an authentication and ownership method according to the present invention.

FIG. 2B is a continuation of FIG. 2A.

FIG. 3A is an authentication and ownership database according to the present invention.

FIG. 3B is a continuation of FIG. 3A.

Similar reference characters denote corresponding features consistently throughout the attached drawings.

### DETAILED DESCRIPTION OF THE PREFERRED EMBODIMENTS

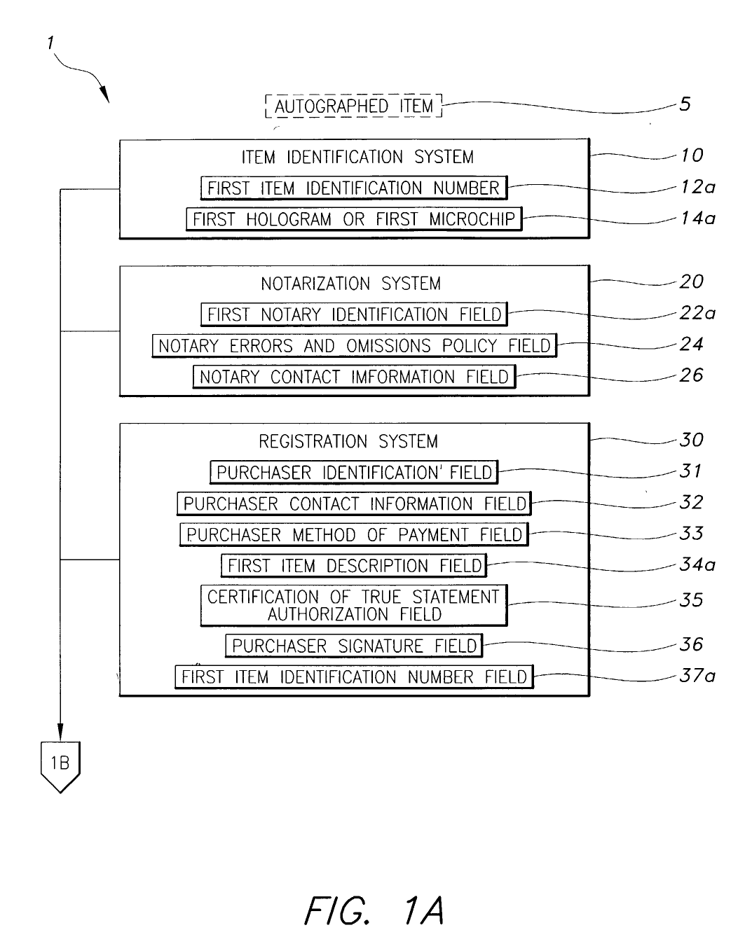

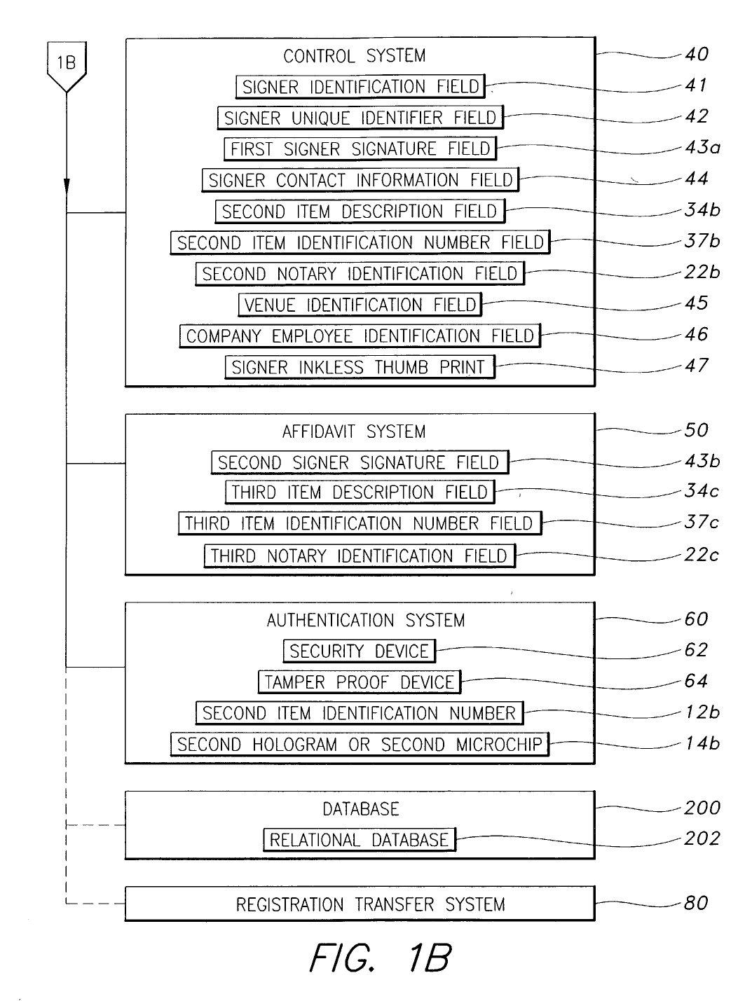

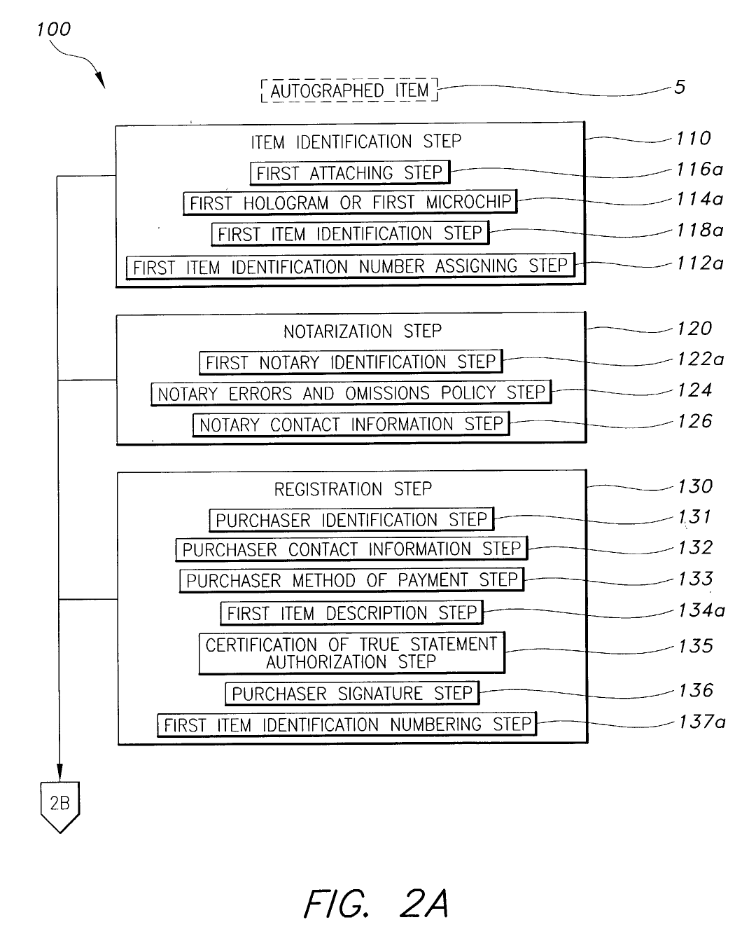

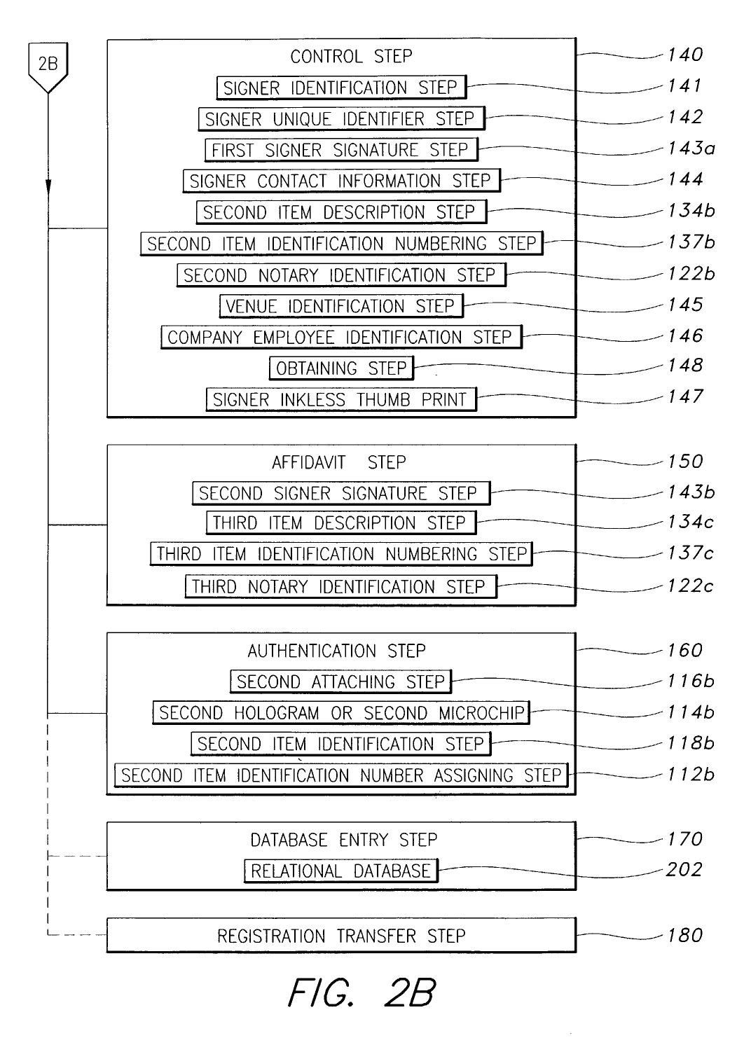

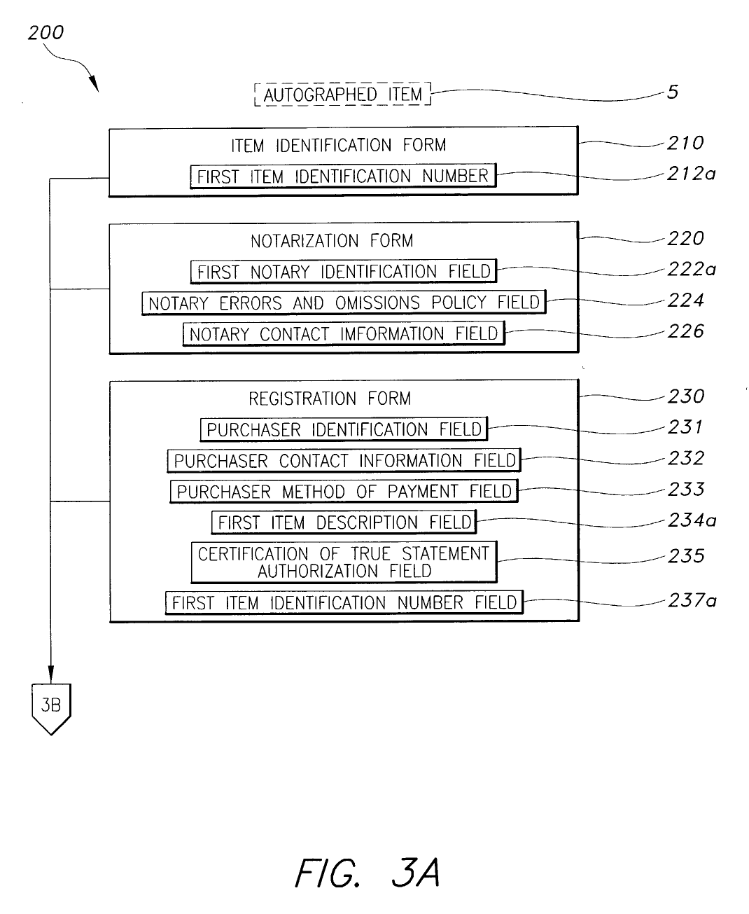

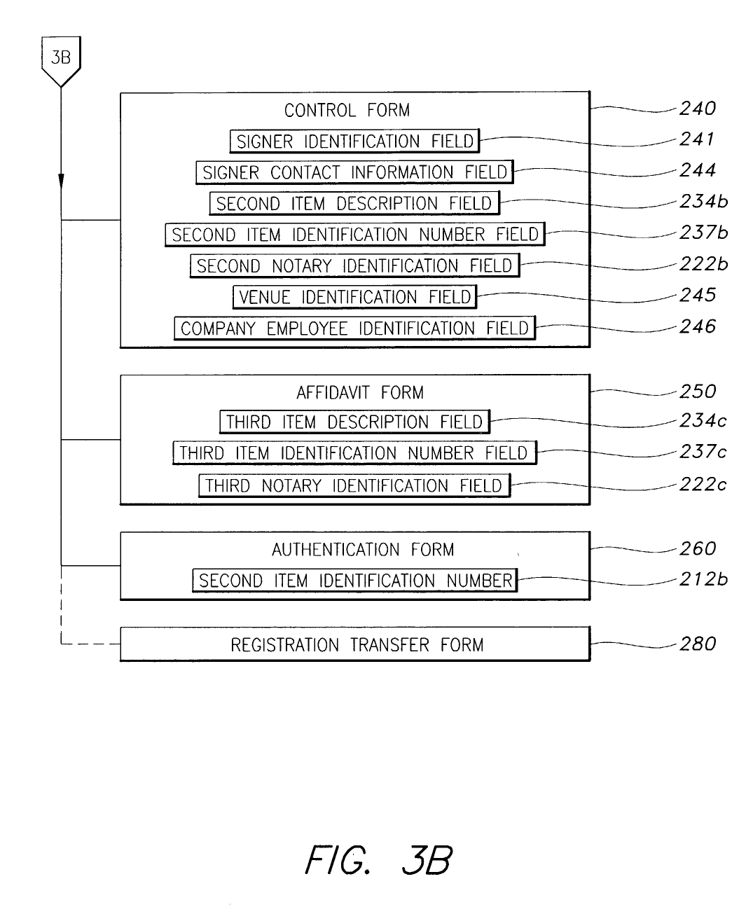

The present invention is directed to an authentication and ownership system 1 (FIGS. 1A and 1B), an authentication and ownership method 100 (FIGS. 2A and 2B) and an authentication and ownership database 200 (FIGS. 3A and 3B) for one or more items to be signed or previously autographed items 5. In the case of previously autographed items, the system would have to subsequently verify that the signature on the autographed item 5 is their own.

The system 1, method 100 and database 200 of the present invention enable a person or company (the “authenticator”) to control the methodology whereby an item is autographed and thus provide validity, authentication and integrity in the collector marketplace. The present invention substantially reduces counterfeiting and fraud.

For the purposes of this disclosure, “autographed item” means a previously autographed item or an item that is intended to be autographed. The autographed item may also be a plurality of such items. An autograph may be a signature, mark or any identifying insignia associated with a person, or, possibly, an animal or thing. As noted in detail below, the present invention may be applied to items before, during or after an item is autographed.

A signer, particularly a celebrity, would be encouraged to use the services of the authenticator using the present invention in order to further safeguard his or her signature from counterfeiting. With increased assurance in the legitimacy of any particular autographed item 5, the value of the item increases in the marketplace.

The authenticator has an interest in the elimination of counterfeiting. The authenticator is preferably not an active participant in the sale of memorabilia. The authenticator may serve as a depository for members of the marketplace.

The present invention is particularly useful in authenticating the autographs of sports figures, celebrities and artists on all types of memorabilia, art and collectibles, and then establishing an owner of the authenticated, autographed item 5. The present invention is adapted for use during any public or private signing of art, memorabilia or collectibles. The present invention is preferably implemented by insured and/or bonded personnel of the authenticator with a vested interest in the success of the authenticator.

The present invention enables the authenticator to offer ownership of the autographed item 5, prevents counterfeiting, and allows for systematic transfer of ownership with confidence in the marketplace. The present invention is not exclusive and adapted for use with any participant in the market for autographed items 5, including private, public and estate signings. By using the present invention, an owner can be assured that the autographed item 5 was actually signed by the person identified by the seller as the signer. Thus, the present invention stabilizes the value of the autographed item 5. Because the present invention permits an authenticator who only has an interest in acknowledging, registering and verifying the signature on the autographed item 5, the present invention eliminates the conflict of interest that often occurs in the marketplace due to the potential profit in selling counterfeit memorabilia.

For a private signing, i.e. a signing not publicly viewed or publicized, it is preferable that the signing of the item be video recorded in a “locked on” position. The video recording may be transferred to a compact disc or other suitable medium. These procedures would provide additional accountability.

In summary, the present invention establishes the authenticity and ownership of an autographed item 5 by uniquely identifying the item to be signed, witnessing the signing of the item by an authorized notary, registering the uniquely identified item, controlling all information related to the signing and transfer of ownership of the item, attesting to the signing of the item on an affidavit, and issuing a certificate of authenticity to the owner of the item. The owner may then transfer ownership of the autographed item 5 to another.

The system 1 of the present invention records and stores the information generated during the method 100 of the present invention. A database 200 may be used to manage the information generated in using the system 1 and method 100.

Throughout the specification, the systems, steps and database fields of the present invention are, in some cases, identified with the terms “first,” “second,” and sometimes “third.” However, the present invention need not necessarily be performed in the order presented herein and may be adapted to suit the particular needs of the authenticator and the nature of the item to be authenticated. The present invention or portions of the present invention may be implemented before, during or after an item is autographed.

In a first embodiment, the authentication and ownership system 1 (FIGS. 1A and 1B) comprises an item identification system 10, a notarization system 20, a registration system 30, a control system 40, an affidavit system 50, and an authentication system 60. The system 1 may be a series of paper forms onto which information about the autographed item 5 may be manually or mechanically recorded. The system 1 may also be a computer system which displays a series of database screens into which information about the autographed item 5 may be recorded via an input device, such as a keyboard.

The system 1 may be a combination of manual, mechanical and/or computerized data collection systems. The system 1 may be any suitable device or apparatus for collecting and storing information about the autographed item 5 which may include information about the item, a notary, a purchaser, a signer of the item, a venue in which the signing took place, and the authenticator. The types of information which may be recorded will be discussed in greater detail below.

The item identification system 10 may comprise any suitable device for uniquely identifying the autographed item 5 with a first unique identifier, such as a number. The first unique identifier may be encoded into the device. The item identification system 10 may be a security device which discourages counterfeiting.

The notarization system 20 may comprise any suitable device for recording and storing information about the notary. The notary may be an employee of the authenticator or in a contractual relationship with the authenticator.

The registration system 30 may comprise any suitable device for recording and storing information about the purchaser and the autographed item 5. The registration system 30 may be adapted to record and store information about the item and/or the first unique identifier assigned by the item identification system 10.

The control system 40 may comprise any suitable device for recording and storing information about the signer, the autographed item 5, the venue, the notary, and the authenticator. The control system 40 may be adapted to record and store information about the item and/or the first unique identifier assigned by the item identification system 10. Preferably, the authorized notary, under the supervision of the authenticator may use the control system 40 to record and store information. The control system 40 would also preferably become the property of the authenticator.

The affidavit system 50 may comprise any suitable device for recording and storing information about the signer, the autographed item 5, and the notary. The affidavit system 50 may be adapted to record and store information about the item and/or the first unique identifier assigned by the item identification system 10.

The authentication system 60 may comprise any suitable device for recording and storing information about the autographed item 5. The authentication system 60 may comprise any suitable device for uniquely identifying an item with a second unique identifier, such as a number. The second unique identifier may be encoded into the device.

In a second embodiment, the system 1 includes the features of the first embodiment and further comprises a database 200. The database 200 is adapted to record and store all the information collected by the item identification system 10, the notarization system 20, the registration system 30, the control system 40, the affidavit system 50, and the authentication system 60. The database 200 enables the authenticator to efficiently manage the information collected by the system 1. The database 200 may include identifying notes about the signing transaction in order to further secure system 1 from fraud.

In a third embodiment, the system 1 includes the features of the first embodiment and further comprises a registration transfer system 80. The registration transfer system 80 may comprise any suitable device for recording and storing information about the seller, the autographed item 5, and a buyer. The registration transfer system 80 may also be adapted to record and store information about the first unique identifier assigned by the item identification system 10 and the second unique identifier assigned by the authentication system 60.

The registration transfer system 80 of the present invention is useful in that it provides continuity, i.e. a historical record, an audit trail, or a chain of title, between a buyer and seller with respect to the autographed item 5. Further, the seller of the autographed item 5 may provide the buyer with the first unique identifier assigned by the item identification system 10 and the second unique identifier assigned by the authentication system 60. Such information may not be visible if it is encoded into the item identification system 10 and the authentication system 60. Next, the buyer can independently check this information against the information in the system 1 which is maintained by the authenticator. If the information matches, then the buyer has independent verification that the item being purchased or transferred is actually the autographed item 5 and not a counterfeit.

In a fourth embodiment, the system 1 includes the features of the first embodiment and the notarization system 20 further comprises a first notary identification field 22a, the control system 40 further comprises a second notary identification field 22b, and the affidavit system 50 further comprises a third notary identification field 22c. As such, the information in the control system 40 and the affidavit system 50 are independently verified by a notary who has been approved by the authenticator.

In a fifth embodiment, the system 1 includes the features of the first embodiment and is further characterized in that the item identification system 10 is adapted to be identified with a first item identification number 12a, and the authentication system 60 is adapted to be identified with a second item identification number 12b. This feature is useful in that the purchaser of the autographed item 5 will have two unique identifiers, the first item identification number 12a is encoded into the item identification system 10 which is attached to the autographed item 5, and the second item identification number 12b is attached to the authentication system 12b. As such, the purchaser of the autographed item 5 becomes an owner. When the owner is ready to sell the autographed item 5 to a subsequent purchaser, as noted above, the owner may use the registration transfer system 80 and the first and second identification numbers 12a, 12b to prove to the subsequent purchaser that the item being purchased or transferred is actually the autographed item 5 and not a counterfeit.

A sixth embodiment includes the features of the first, fourth and fifth embodiments, noted above, and includes first and second tamper proof and permanently attached security devices, one attached to the autographed item 5 and another attached to the authentication system 60. Also, the sixth embodiment includes additional information about the signer and the autographed item 5.

Specifically, in the sixth embodiment, the item identification system 10 is tamper proof and adapted to be permanently attached to the autographed item 5, and adapted to be identified with a first item identification number 12a. The notarization system 20 further comprises a first notary identification field 22a. The registration system 30 further comprises a first item description field 34a, and a first item identification number field 37a. The control system 40 further comprises a first signer signature field 43a, a second item description field 34b, a second item identification number field 37b, and a second notary identification field 22b.

Further, in the sixth embodiment, the affidavit system 50 further comprises a second signer signature field 43b, a third item description field 34c, a third item identification number field 37c, and a third notary identification field 22c. The authentication system 60 further comprises a tamper proof device 64 which is adapted to be permanently attached to the authentication system 60 and is adapted to be identified with a second item identification number 12b.

A seventh embodiment includes the features of first, fourth, fifth and sixth embodiments, noted above, and includes first and second holograms or microchips 14a, 14b, or the like, a signer inkless thumb print 47, a security device 62, and a relational database 202. Also, the seventh embodiment includes additional information about the notary, the purchaser, the method of payment, the signer, the venue, the authenticator.

Specifically, in the seventh embodiment, the system 1 further comprises a relational database 202 and a registration transfer system 80, as described above with respect to the third embodiment. The relational database 202 is a collection of data items organized as a set of formally-described tables from which data can be accessed or reassembled in many different ways without having to reorganize the database tables. The relational database 202 permits the authenticator greater flexibility in managing the data collected from the system 1.

The item identification system 10 of the seventh embodiment is either a first hologram or a first microchip 14a which is tamper proof and adapted to be permanently attached to the autographed item 5. The item identification system 10 is adapted to be identified with a first item identification number 12a. The item identification system 10 may be a proprietary item of the authenticator. The item identification system 10 may be affixed to the item either at the authenticator's facility or at a third-party signing area, depending on the lead time required in order to affix the item identification system 10 to the item.

The notarization system 20 of the seventh embodiment comprises a first notary identification field 22a, a notary errors and omissions policy field 24, and a notary contact information field 26. It is preferable that the authenticator supervise the notary and maintain a list of insured and commissioned notaries public. The list may be stored in a database, such as database 200. It is also preferable that all pertinent data be on hand and available at any given signing location. These conditions help ensure that the notaries are pre-approved by the authenticator.

Preferably, a notary will provide the authenticator with a photograph identification, a copy of the notary's error and omissions policy with a minimum suitable coverage (on the order of $25,000), a certificate of official character which includes the commission number and expiration date of the commission, a notary identification card, and contact information. Further, it is preferable that the notary be in a contractual relationship with the authenticator to further assure that an authorized notary is present at a signing event.

The registration system 30 of the seventh embodiment comprises a purchaser identification field 31, a purchaser contact information field 32, a purchaser method of payment field 33, a first item description field 34a, a certification of true statement authorization field 35, a purchaser signature field 36, and a first item identification number field 37a.

The purchaser identification and contact information fields 31, 32 may include name, address, telephone, e-mail and other similar types of information. The purchaser method of payment field 33 may include credit card or cash transaction information. The certification of true statement authorization field 35 may be a statement whereby the purchaser certifies that information provided on the registration system 30 is true. If the purchaser is using a credit card, the certification of true statement authorization field 35 may further include a statement whereby the purchaser authorizes use of the credit card for the payment of any fees in connection with the registration system 30. The first item identification number field 37a may be adapted to receive the first item identification number 12a or any other unique identifier of the autographed item 5.

The registration system 30 may preferably be a form which is filled out on the Internet, at a public show, or at a private signing. The registration system 30 may be used for individual consumers, celebrities, sports figures, or companies that sell memorabilia. The form may be made available at the place of signing and may be provided in duplicate form such that a duplicate is retained by the consumer, celebrity, sports figure, or company completing the form. The original form is preferably made the property of the authenticator. The form may be adapted such that the information contained on the form is easily input into a database 200 via manual entry, machine scan or direct entry via an input device. As noted above, the form may be computerized for more direct and accurate entry into the database 200. A form is preferably completed for each item or group of items.

In a preferred procedure, the purchaser completes a registration form that is a part of the registration system 30 of the present invention. The registration form may be completed at a facility provided by the authenticator. Optionally, the purchaser may pre-register prior to the signing of the item by completing the form in advance, possibly on the Internet, in which case proper identification will be required. Once the registration form is completed or picked up, the purchaser may proceed to the signer.

The item listed on the registration form is given to the signer and the registration form is given to an employee of the authenticator. The employee views every signature that is signed on every item. The employee, in view of the signer, may affix to the item the item identification system 10, which, as noted above, is encoded with a first unique identifier. The first unique identifier may also be recorded on the registration form. The authenticator preferably retains the original registration form, and the purchaser preferably receives a duplicate copy of the registration form, which may be used as a receipt.

The control system 40 of the seventh embodiment comprises a signer identification field 41, a signer unique identifier field 42, a first signer signature field 43a, a signer contact information field 44, a second item description field 34b, a second item identification number field 37b, a second notary identification field 22b, a venue identification field 45, and a company employee identification field 46.

The signer unique identifier field 42 is adapted to receive a signer inkless thumb print 47. If the system 1 is an electronic or computerized system, then the signer unique identifier field 42 is adapted to receive an electronic version of the signer inkless thumb print 47. The second item description in the second item description field 34b preferably matches the first item description in the first item description field 34a of the registration system 30. The second item identification number field 37b may be adapted to receive the first item identification number 12a or any other unique identifier of the autographed item 5. The second notary identification in the second notary identification field 22b preferably matches the first notary identification in the first notary identification field 22b

The affidavit system 50 of the seventh embodiment comprises a second signer signature field 43b, a third item description field 34c, a third item identification number field 37c, and a third notary identification field 22c. It is preferable that an affidavit be signed affirming the signature of the person signing the item. This affidavit would preferably include the description of the item, quantity of items signed if more than one, and any unique identifer used to identify the item. The affidavit is preferably notarized in accordance with the notarization system 20. The affidavit system 50 may be stored electronically and an original may be stored. There may be another affidavit in cases when the memorabilia has been signed in the past and/or when the signer wishes to verify a large collection.

The information in the second signer signature field 43b, the third item description field 34c, the third item identification number field 37c, and the third notary identification field 22c preferably match the information in the first signer signature field 43a, the first and second item description fields 34a, 34b, the first and second item identification number fields 37a, 37b, and the first and second notary identification fields 22a and 22b. The third item identification number field 37c may be adapted to receive the first item identification number 12a or any other unique identifier of the autographed item 5.

The authentication system 60 of the seventh embodiment comprises a security device 62, and a tamper proof device 64 which is adapted to be permanently attached to the authentication system 60 and is adapted to be identified with a second item identification number 12b. The security device 62 may be security stock paper and may have encoded properties. The tamper proof device 64 is either a second hologram or a second microchip 14b which is affixed to the authentication system 60. The second hologram or a second microchip 14b may contain data and may be permanently attached to the authentication system 60. The authentication system 60 may take the form of a certificate of authenticity. The second item identification number 12b may be the same as the first item identification number 12a, or may be associated with the first item identification number 12a in such a manner that would enable the authenticator and/or other authorized parties to associate the authentication system 60 with the item identification system 10. Alternately, the second hologram or second microchip 14b may be a duplicate of the first hologram or first microchip 14a.

Once the authentication system 60 is given to the person recorded on the registration system 30, that person becomes the registered owner of the autographed item 5. The authentication system 60 may itself include the registration transfer system 80 in order to facilitate a continuing registration process and audit trail for the autographed item 5.

As noted above, the present invention is also directed to the authentication and ownership method 100 (FIGS. 2A and 2B) for one or more items to be autographed or the previously autographed items 5. Steps of the method 100 which correspond with similar features of the system 1 and database 200 are designated with a similar reference number.

In an eighth embodiment, the authentication and ownership method 100 comprises an item identification step 110, a notarization step 120, a registration step 130, a control step 140, an affidavit step 150, and an authentication step 160.

In the item identification step 110, the autographed item 5 may be identified using any suitable device for identifying the item with a first unique identifier, such as a number. The first unique identifier may be encoded into the device. The item identification step 110 may include attaching a security device which discourages counterfeiting to the autographed item 5.

In the notarization step 120, information about a notary may be recorded and stored using any suitable device for recording and storing such information. The notary may be an employee of the authenticator or in a contractual relationship with the authenticator.

In the registration step 130, information about the purchaser and the autographed item 5 may be recorded and stored using any suitable device for recording and storing such information. During the registration step 130, information about the item and/or the first unique identifier assigned during the item identification step 110 may be recorded and stored.

In the control step 140, information about the signer, the autographed item 5, the venue, the notary, and the authenticator may be recorded and stored using any suitable device for recording and storing such information. During the control step 140, information about the item and/or the first unique identifier assigned during the item identification step 110 may be recorded and stored. Preferably, the authorized notary, under the supervision of the authenticator may record and store information during the control step 140.

In the affidavit step 150, information about the signer, the autographed item 5, and the notary may be recorded and stored using any suitable device for recording and storing such information. During the affidavit step 150, information about the item and/or the first unique identifier assigned during the item identification step 110 may be recorded and stored.

In the authentication step 160, information about the autographed item 5 may be recorded and stored using any suitable device for recording and storing such information. During the authentication step 160, an item may be uniquely identified with a second unique identifier, such as a number, using any suitable device for uniquely identifying an item. The second unique identifier may be encoded into the device.

In a ninth embodiment, the method 100 includes the features of the eighth embodiment and further comprises a database entry step 170 where information collected during the item identification step 110, the notarization step 120, the registration step 130, the control step 140, the affidavit step 150, and the authentication step 160 is entered into a database 200.

In a tenth embodiment, the method 100 includes the features of the eighth embodiment and further comprises a registration transfer step 180. In the registration transfer step 180, information about the seller, the autographed item 5, and a buyer may be recorded and stored using any suitable device for recording and storing information. During the registration transfer step 180, information about the first unique identifier assigned during the item identification step 110 and the second unique identifier assigned during the authentication step 160 may be recorded and stored.

In an eleventh embodiment, the method 100 includes the features of the eighth embodiment and is further characterized in that the notarization step 120 comprises a first notary identification step 122a, the control step 140 comprises a second notary identification step 122b, and the affidavit step 150 comprises a third notary identification step 122c. As such, the information collected during the control step 140 and the affidavit step 150 are independently verified by a notary who has been approved by the authenticator.

In a twelfth embodiment, the method 100 includes the features of the eighth embodiment and is further characterized in that the item identification step 110 comprises a first item identification step 118a whereby a first unique identifier is assigned to the autographed item 5, and the authentication step 160 comprises a second item identification step 118b whereby a second unique identifier is assigned to the autographed item 5. The second unique identifier may be the same as the first unique identifier, or may be associated with the first unique identifier in such a manner that would enable the authenticator and/or other authorized parties to associate the autographed item 5 during the authentication step 160 and the item identification step 110.

When the owner is ready to sell the autographed item 5 to a subsequent purchaser, the owner may use the registration transfer step 180 and the first and second unique identifers to prove to the subsequent purchaser that the item being purchased or transferred is actually the autographed item 5 and not a counterfeit.

In a thirteenth embodiment, the method 100 includes the features of the eighth, eleventh and twelfth embodiments and further includes item identification attaching steps, item description steps, item identification numbering steps, and signer signature steps.

Specifically, in the thirteenth embodiment, the item identification step 110 comprises a first attaching step 116a whereby a first unique identifier is permanently attached to the autographed item 5, and a first item identification step 118a, as described above.

The notarization step 120 of the thirteenth embodiment comprises a first notary identification step 122a, as described above.

The registration step 130 of the thirteenth embodiment comprises a first item description step 134a whereby information about the autographed item 5 is recorded and stored, and a first item identification numbering step 137a whereby the first and/or second unique identifier is/are recorded and stored.

The control step 140 of the thirteenth embodiment comprises a first signer signature step 143a whereby the signer's signature is recorded and stored, a second item description step 134b whereby information about the autographed item 5 is recorded and stored, a second item identification numbering step 137b whereby the first and/or second unique identifier is/are recorded and stored, and a second notary identification step 122b, as described above.

The affidavit step 150 of the thirteenth embodiment comprises a second signer signature step 143b whereby the signer's signature is recorded and stored, a third item description step 134c whereby information about the autographed item 5 is recorded and stored, a third item identification numbering step 137c whereby the first and/or second unique identifier is/are recorded and stored, and a third notary identification step 122c, as described above.

The authentication step 160 of the thirteenth embodiment comprises a second attaching step 116b whereby a second unique identifier is permanently attached to the autographed item 5, and a second item identification step 118b, as described above.

In a fourteenth embodiment, the method 100 includes the features of the eighth, ninth, tenth, eleventh, twelfth and thirteenth embodiments and further includes the entry of data into a relational database, the attaching of a hologram or microchip, item identification number assigning steps, notary information steps, registration information steps, and control information steps.

Specifically, in the fourteenth embodiment, the method 100 further comprises a database entry step 170 where the database entry step 170 is performed in a relational database 202, and a registration transfer step 180, as described above.

The item identification step 110 of the fourteenth embodiment comprises a first attaching step 116a wherein a first hologram or a first microchip 114a is permanently attached to the autographed item 5, a first item identification step 118a, as described above, and a first item identification number assigning step 112a, as described above.

The notarization step 120 of the fourteenth embodiment comprises a first notary identification step 122a, as described above, a notary errors and omissions policy step 124 whereby information about the notary's error and omissions policy is recorded and stored, and a notary contact information step 126 whereby contact information about the notary is recorded and stored.

The registration step 130 of the fourteenth embodiment comprises a purchaser identification step 131 whereby identification information about the purchaser is recorded and stored, a purchaser contact information step 132 whereby contact identification information about the purchaser is recorded and stored, a purchaser method of payment step 133, a first item description step 134a, as described above, a certification of true statement authorization step 135 whereby the purchaser certifies that information provided during the registration step 130 is true, a purchaser signature step 136 whereby the purchaser's signature is recorded and stored, and a first item identification numbering step 137a, as described above.

The control step 140 of the fourteenth embodiment comprises a signer identification step 141, a signer unique identifier step 142, a signer contact information step 144, a venue identification step 145, and a company employee identification step 146, whereby information about the signer, the venue and the company employee is recorded and stored. During the signer unique identifier step 142, a signer inkless thumb print 147 is obtained during an obtaining step 148 by applying the finger of the signer to a mechanical or electronic reader which then produces a mechanical or electronic facsimile of the signer's thumb print. The control step 140 of the fourteenth embodiment also includes a first signer signature step 143a, a second item description step 134b, a second item identification numbering step 137b, and a second notary identification step 122b, all of which are described above.

The affidavit step 150 of the fourteenth embodiment comprises a second signer signature step 143b, a third item description step 134c, a third item identification numbering step 137c, and a third notary identification step 122c, all of which are described above.

The authentication step 160 of the fourteenth embodiment comprises a second attaching step 116b wherein a second hologram or a second microchip 114b is permanently attached to an authentication system 60 (see FIGS. 1A and 1B), and a second item identification step 118b comprising a second item identification number assigning step 112b, as described above.

As noted above, the present invention is also directed to the authentication and ownership database 200 (FIGS. 3A and 3B) for autographed items 5. Features of the database 200 which correspond with similar features of the system 1 and method 100 are designated with a similar reference number.

In a fifteenth embodiment, an authentication and ownership database 200 for one or more autographed items 5 comprises an item identification form 210, a notarization form 220, a registration form 230, a control form 240, an affidavit form 250, and an authentication form 260.

In a sixteenth embodiment, the database 200 includes the features of the fifteenth embodiment and further comprises a registration transfer form 280.

In a seventeenth embodiment, the database 200 includes the features of the fifteenth embodiment and is further characterized in that the notarization form 220 comprises a first notary identification field 222a, the control form 240 comprises a second notary identification field 222b, and the affidavit form 250 comprises a third notary identification field 222c.

In an eighteenth embodiment, the database 200 includes the features of the fifteenth embodiment and is further characterized in that the item identification form 210 is adapted to be identified with a first item identification number 212a, and the authentication form 260 is adapted to be identified with a second item identification number 212b.

In a nineteenth embodiment, the database 200 includes the features of the fifteenth, seventeenth and eighteenth embodiments and further comprises item description fields.

Specifically, in the nineteenth embodiment, the item identification form 210 is adapted to be identified with a first item identification number 212a. The notarization form 220 comprises a first notary identification field 222a. The registration form 230 comprises a first item description field 234a, and a first item identification number field 237a. The control form 240 comprises a second item description field 234b, a second item identification number field 237b, and a second notary identification field 222b. The affidavit form 250 comprises a third item description field 234c, a third item identification number field 237c, and a third notary identification field 222c. The authentication form 260 is adapted to be identified with a second item identification number 212b.

In a twentieth embodiment, the database 200 includes the features of the fifteenth, sixteenth, seventeenth, eighteenth and nineteenth embodiments and is further characterized in that the database 200 is a relational database, and the database 200 further comprises notary information fields, registration information fields, and control information fields.

Specifically, in the twentieth embodiment, the database 200 is a relational database and further comprises a registration transfer form 280.

The item identification form 210 of the twentieth embodiment is adapted to be identified with a first item identification number 212a.

The notarization form 220 of the twentieth embodiment comprises a first notary identification field 222a, a notary errors and omissions policy field 224, and a notary contact information field 226.

The registration form 230 of the twentieth embodiment comprises a purchaser identification field 231, a purchaser contact information field 232, a purchaser method of payment field 233, a first item description field 234a, a certification of true statement authorization field 235, and a first item identification number field 237a.

The control form 240 of the twentieth embodiment comprises a signer identification field 241, a signer contact information field 244, a second item description field 234b, a second item identification number field 237b, a second notary identification field 222b, a venue identification field 245, and a company employee identification field 246.

The affidavit form 250 of the twentieth embodiment comprises a third item description field 234c, a third item identification number field 237c, and a third notary identification field 222c.

The authentication form 260 of the twentieth embodiment is adapted to be identified with a second item identification number 212b.

It is to be understood that the present invention is not limited to the embodiments described above, but encompasses any and all embodiments within the scope of the following claims.

I claim:

1. An authentication and ownership system for one or more items to be signed or previously autographed items, the system comprising:
an item identification system;
a notarization system;
a registration system;
a control system;
an affidavit system; and
an authentication system.

2. The authentication and ownership system of claim 1, wherein the authentication and ownership system further comprises a database.

3. The authentication and ownership system of claim 1, wherein the authentication and ownership system further comprises a registration transfer system.

4. The authentication and ownership system of claim 1, wherein the notarization system comprises a first notary identification field;
wherein the control system comprises a second notary identification field; and
wherein the affidavit system comprises a third notary identification field.

5. The authentication and ownership system of claim 1, wherein the item identification system is adapted to be identified with a first item identification number; and
wherein the authentication system is adapted to be identified with a second item identification number.

6. The authentication and ownership system of claim 1, wherein the item identification system is tamper proof and adapted to be permanently attached to the autographed item, and wherein the item identification system is adapted to be identified with a first item identification number;
wherein the notarization system comprises a first notary identification field;
wherein the registration system comprises a first item description field, and a first item identification number field;
wherein the control system comprises a first signer signature field, a second item description field, a second item identification number field, and a second notary identification field;
wherein the affidavit system comprises a second signer signature field, a third item description field, a third item identification number field, and a third notary identification field; and
wherein the authentication system comprises a tamper proof device which is adapted to be permanently attached to the authentication system and is adapted to be identified with a second item identification number.

7. The authentication and ownership system of claim 1, wherein the authentication and ownership system further comprises a relational database, and a registration transfer system;
wherein the item identification system is tamper proof and adapted to be permanently attached to the autographed item, wherein the item identification system is adapted to be identified with a first item identification number, and wherein the item identification system is a first hologram or a first microchip;
wherein the notarization system comprises a first notary identification field, a notary errors and omissions policy field, and a notary contact information field;
wherein the registration system comprises a purchaser identification field, a purchaser contact information field, a purchaser method of payment field, a first item description field, a certification of true statement authorization field, a purchaser signature field, and a first item identification number field;
wherein the control system comprises a signer identification field, a signer unique identifier field, a first signer signature field, a signer contact information field, a second item description field, a second item identification number field, a second notary identification field, a venue identification field, and a company employee identification field, and wherein the signer unique identifier field is adapted to receive a signer inkless thumb print;
wherein the affidavit system comprises a second signer signature field, a third item description field, a third item identification number field, and a third notary identification field;
wherein the authentication system comprises a security device, and a tamper proof device which is adapted to be permanently attached to the authentication system and is adapted to be identified with a second item identification number; and
wherein the tamper proof device is a second hologram or a second microchip.

8. An authentication and ownership method for one or more items to be signed or previously autographed items, the method comprising:
an item identification step;
a notarization step;
a registration step;
a control step;
an affidavit step; and
an authentication step.

9. The authentication and ownership method of claim 8, wherein the authentication and ownership method further comprises a database entry step.

10. The authentication and ownership method of claim 8, wherein the authentication and ownership method further comprises a registration transfer step.

11. The authentication and ownership method of claim 8, wherein the notarization step comprises a first notary identification step;
wherein the control step comprises a second notary identification step; and
wherein the affidavit step comprises a third notary identification step.

12. The authentication and ownership method of claim 8, wherein the item identification step comprises a first item identification step; and
wherein the authentication step comprises a second item identification step.

13. The authentication and ownership method of claim 8, wherein the item identification step comprises a first attaching step, and a first item identification step;
wherein the notarization step comprises a first notary identification step;
wherein the registration step comprises a first item description step, and a first item identification numbering step;
wherein the control step comprises a first signer signature step, a second item description step, a second item identification numbering step, and a second notary identification step;
wherein the affidavit step comprises a second signer signature step, a third item description step, a third item identification numbering step, and a third notary identification step; and
wherein the authentication step comprises a second attaching step, and a second item identification step.

14. The authentication and ownership method of claim 8, wherein the authentication and ownership method further comprises a database entry step, and a registration transfer step;
wherein the database entry step is performed in a relational database;
wherein the item identification step comprises a first attaching step wherein a first hologram or a first microchip is permanently attached to the autographed item;
wherein the item identification step comprises a first item identification step, and a first item identification number assigning step;
wherein the notarization step comprises a first notary identification step, a notary errors and omissions policy step, and a notary contact information step;
wherein the registration step comprises a purchaser identification step, a purchaser contact information step, a purchaser method of payment step, a first item description step, a certification of true statement authorization step, a purchaser signature step, and a first item identification numbering step;
wherein the control step comprises a signer identification step, a signer unique identifier step, a first signer signature step, a signer contact information step, a second item description step, a second item identification numbering step, a second notary identification step, a venue identification step, a company employee identification step, and wherein the signer unique identifier step comprises an obtaining step where a signer inkless thumb print is obtained;
wherein the affidavit step comprises a second signer signature step, a third item description step, a third item identification numbering step, and a third notary identification step; and
wherein the authentication step comprises a second attaching step wherein a second hologram or a second microchip is permanently attached to an authentication system, and a second item identification step comprising a second item identification number assigning step.

15. An authentication and ownership database for one or more items to be signed or previously autographed items, the database comprising:
an item identification form;
a notarization form;
a registration form;
a control form;
an affidavit form; and
an authentication form.

16. The authentication and ownership database of claim 15, wherein the authentication and ownership database further comprises a registration transfer form.

17. The authentication and ownership database of claim 15, wherein the notarization form comprises a first notary identification field;
wherein the control form comprises a second notary identification field; and
wherein the affidavit form comprises a third notary identification field.

18. The authentication and ownership database of claim 15, wherein the item identification form is adapted to be identified with a first item identification number; and
wherein the authentication form is adapted to be identified with a second item identification number.

19. The authentication and ownership database of claim 15, wherein the item identification form is adapted to be identified with a first item identification number;
wherein the notarization form comprises a first notary identification field;
wherein the registration form comprises a first item description field, and a first item identification number field;
wherein the control form comprises a second item description field, a second item identification number field, and a second notary identification field;
wherein the affidavit form comprises a third item description field, a third item identification number field, and a third notary identification field; and
wherein the authentication form is adapted to be identified with a second item identification number.

20. The authentication and ownership database of claim 15, wherein the authentication and ownership database is a relational database;
wherein the authentication and ownership database further comprises a registration transfer form;
wherein the item identification form is adapted to be identified with a first item identification number;
wherein the notarization form comprises a first notary identification field, a notary errors and omissions policy field, and a notary contact information field;
wherein the registration form comprises a purchaser identification field, a purchaser contact information field, a purchaser method of payment field, a first item description field, a certification of true statement authorization field, and a first item identification number field;
wherein the control form comprises a signer identification field, a signer contact information field, a second item description field, a second item identification number field, a second notary identification field, a venue identification field, and a company employee identification field;
wherein the affidavit form comprises a third item description field, a third item identification number field, and a third notary identification field; and
wherein the authentication form is adapted to be identified with a second item identification number.
